(19) United States
(12) Patent Application Publication
(10) Pub. No.: US 2008/0060685 A1
(43) Pub. Date: Mar. 13, 2008

(54) PULSED-GAS AGITATION PROCESS FOR ENHANCING SOLID SURFACE BIOLOGICAL REMOVAL EFFICIENCY OF DENSE PHASE FLUIDS

(76) Inventors: John S. Novak, Newark, DE (US); James T.C. Yuan, Yorktown Heights, NY (US)

Correspondence Address: AIR LIQUIDE INTELLECTUAL PROPERTY DEPT., 2700 POST OAK BLVD., SUITE 1800, HOUSTON, TX, 77056, US

(21) Appl. No.: 11/779,728

(22) Filed: Jul. 18, 2007

Related U.S. Application Data
(60) Provisional application No. 60/843,126, filed on Sep. 8, 2006.

(51) Int. Cl. B08B 3/02

(52) U.S. Cl. 134/37; 134/56 R

(57) ABSTRACT

Methods and systems for cleaning articles include a vessel into which the article is disposed and accompanying equipment associated with a fluid source to deliver pulses of dense phase gas to the vessel. Cleaning of the articles occurs by removing debris from the surfaces of the articles and/or by inactivating microorganisms on the articles. Repeating inflow and outflow cycles of the dense phase gas into and from the vessel during a cleaning operation improves the cleaning.

### CROSS-REFERENCE TO RELATED APPLICATIONS

This application claims the benefit under 35 U.S.C. § 119(e) to provisional application No. 60/843,126, filed Sep. 8, 2006, the entire contents of which are incorporated herein by reference.

### BACKGROUND

Various different approaches exist for cleansing items whether the cleansing involves removal of debris from the items and/or killing or inactivation of microorganisms such as pathogenic bacteria, virus or fungi. Some of these approaches may cleanse and even sterilize articles such as food, clothing, medical equipment, and surfaces of any other type of object. For example, sterilization of articles can be achieved with chemical disinfectants, irradiation, and heating (such as with an autoclave).

An effective and oftentimes advantageous cleaning technique uses liquid or supercritical carbon dioxide (CO₂) that may be introduced into a pressurized cleansing tank in which the article to be cleansed is disposed. Utilizing liquid carbon dioxide provides a proven, cost effective and environmentally acceptable cleaning agent with chemically inert properties. Introducing agitation to a cleaning fluid intensifies the cleaning effect and helps reduce concentration gradients of the carbon dioxide in the cleaning fluid that can result in the article being exposed to insufficient levels of carbon dioxide for effective cleaning. However, known agitators add cost and complexity to systems, may not be suitable for all applications, and may still fail to prevent formation of the concentration gradients. Further, effectiveness of a closed batch system that does not continually replenish the cleaning fluid with fresh cleaning fluid can deteriorate as a defined amount of the carbon dioxide in the system becomes diluted by detached materials removed from the object being cleaned.

Therefore, there exists a need for methods and apparatus for cleaning items.

### SUMMARY

In one embodiment, a system for cleaning articles includes a cleaning pressure vessel defining an interior volume for containing the article. A fluid source couples via an inlet line to the vessel and supplies a dense phase gas to the interior volume of the vessel. A controller repeatedly cycles pressure inside the vessel between identified minimum and maximum pressures throughout a cleaning process by being configured to pulse flow from the fluid source to the vessel.

For one embodiment, a method of cleaning articles includes placing an article inside a cleaning vessel and supplying a fluid pulse from a source for a dense phase gas to the inside of the cleaning vessel. The method further includes relieving pressure from the inside of the cleaning vessel and repeating supplying of the fluid pulse to repeatedly cycle pressure inside the vessel between identified minimum and maximum pressures during the cleaning of the article. This cycling improves cleaning of the article prior to removing the article from the vessel.

According to one embodiment, a method of cleaning an article includes exposing a solid external surface of the article to a dense phase gas disposed inside a cleaning vessel. Pulsing flow of the dense phase gas passing through the inside of the vessel occurs while the article is disposed in the vessel. The pulsing flow creates repeated up and down pressure fluctuations inside the vessel.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 illustrates a system for cleaning articles disposed inside a vessel of the system utilizing a pulsed flow of a dense phase gas into the vessel, according to one embodiment of the invention; and

FIG. 2 illustrates a flow chart for a method of cleaning articles utilizing a pulsed flow of a liquefied or dense phase gas into a vessel in which the article is disposed, according to one embodiment of the invention.

### DESCRIPTION OF PREFERRED EMBODIMENTS

Embodiments generally relate to cleaning of articles. The articles may include solid food, clothing, medical equipment, and any other objects having cleanable surfaces that may be made of, for example, glass or metals. The system cleans the articles by removing debris, such as attached cells, polymers and biofilm, from the surfaces of the articles and/or by inactivating microorganisms, such as pathogens, bacteria, viruses and fungi, on the articles. The system includes a vessel into which the article is placed or otherwise disposed prior to delivering pulses of a dense phase gas (e.g., liquefied gas or supercritical gas) to the vessel. Liquefied gas as used herein refers to a particular mixture of one or more gasses, such as carbon dioxide, maintained at pressures and temperatures associated with the liquid phase of the respective particular gases in pure form. Repeating inflow and outflow cycles of the dense phase gas into and from the vessel create the pulses of flow and maintain cleaning fluid contents inside the vessel continuously in a state of flux.

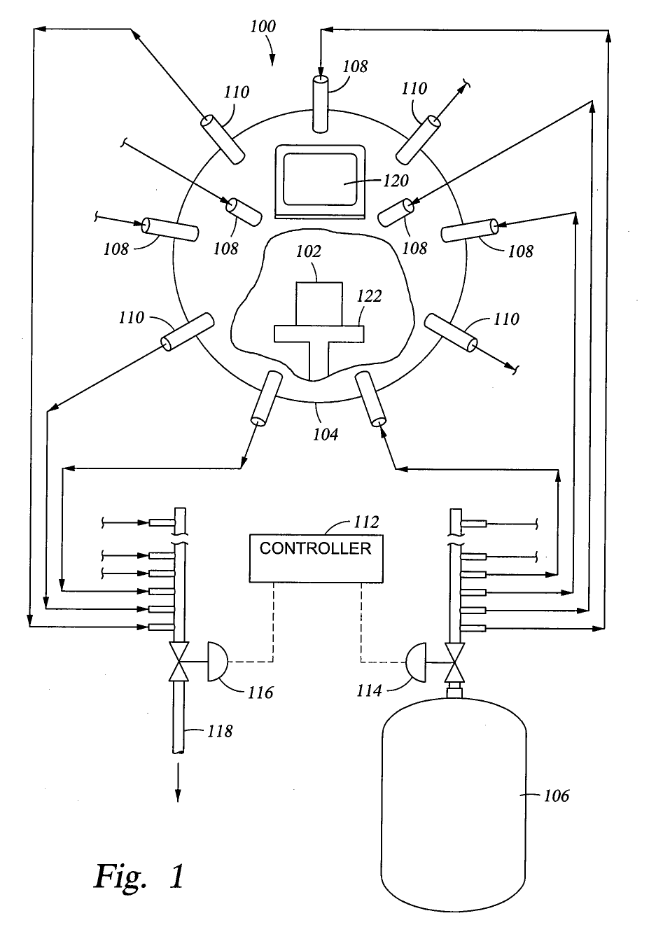

FIG. 1 shows a system 100 for cleaning articles 102 disposed inside a closed vessel 104 of the system 100. The system 100 additionally includes a source 106 of a dense phase gas, at least one inlet line 108 coupling the source 106 to the vessel 104, at least one outlet line 110 exiting from the vessel 104, and a controller 112 that manipulates operation of inflow and outflow valves 114, 116 disposed respectively along the inlet and outlet lines 108, 110. For some embodiments, multiple ones (e.g., about 5 or more or about 10 or more) of the inlet line 108 and multiple ones (e.g., about 5 or more or about 10 or more) of the outlines line 110 may be spaced about the vessel 104 for fluid communication with an interior of the vessel 104 at different locations via respective porting. This distribution of the inlet and outlet lines 108, 110 may facilitate dispersed entry and exit of the dense phase gas into and from the vessel 104. A spherical shape of the vessel 104 in some embodiments further aids in even and rapid distribution of the dense phase gas inside the vessel 104 by avoiding dead spots. While other shapes such as rectangular or barrel are contemplated, the spherical shape of the vessel 104 also aides in providing structural stability required for the vessel 104 to withstand supercritical pressures.

A door 120 enables access to a hollow interior volume forming the inside of the vessel 104 to permit placement of the article 102 inside the vessel 104 and subsequent removal of the article 102 after cleaning. The article 102 may rest on a support 122 extending toward a center of the inside of the vessel 104. This position of the article 102 and aforementioned flushing of the vessel 104 using the equidistant (according to one embodiment) inlet and outlet lines 108, 110 promote uniform and reproducible treatments as described herein. Closing the door 120 seals the vessel 104 except for passageways through the inlet and outlet lines 108, 110, which are regulated by the inflow and outflow valves 114, 116.

A cleaning fluid for some embodiments may contain at least one dense phase gas that is injected into the vessel 104 from the source 106 via the inlet line 108. The dense phase gasses may flow into the vessel 104 independent or together with other constituents of the cleaning fluid. In some embodiments, the dense phase gas includes carbon dioxide (CO₂) with or without other additives, such as hydrogen peroxide or dense phase gas oxidants, for example ozone (O₃), which enhance the cleaning. The cleaning fluid may include the additives, surfactants and/or solvents along with the dense phase gasses. For example, an aqueous solution containing carbon dioxide may form the cleaning fluid. Gasses other than or in addition to carbon dioxide, either alone or in combination, may be employed in some embodiments under dense fluid conditions. Such gases include, for example, dinitrogen monoxide, sulphur hexafluoride, argon, krypton, xenon, oxygen, helium, hydrocarbons, such as methane, ethane, propane, ethene, and propene, and halogenated hydrocarbons such as trifluoromethane. For exemplary purposes only, carbon dioxide provides the dense phase gas of the cleaning fluid in the description hereinafter.

Although carbon dioxide in most liquids is freely soluble, potential for areas of the cleaning fluid without mixing of the carbon dioxide increases as the concentration of the carbon dioxide increases. For some embodiments, the level of the dense phase gas within the cleaning fluid may be at least 95% by weight, for example. Dense phase carbon dioxide saturation level in the cleaning fluid determines ability of the carbon dioxide to inactivate microorganisms on the article 102. Concentration gradients of the carbon dioxide in the cleaning fluid thus limit efficiency of the cleaning. Ensuring that all of the cleaning fluid is saturated with the carbon dioxide improves throughput, which is based on amount of time required to leave the article 102 in the fluid to kill the microorganisms.

Operation of the controller 112 manipulates the inflow valve 114 to pulse the flow of the carbon dioxide delivered into the vessel 104 from the source 106 during cleaning of the article 102. The outflow valve 116 may also receive actuation signals from the controller 112 to intermittently open and close the outflow valve 116 preventing excess build up of pressure inside the vessel 104. In some embodiments, any pressure relief valve or orifice defines the outflow valve 116. This pulsing agitates the cleaning fluid in the vessel 104 and hence promotes mixing of the carbon dioxide throughout the vessel 104. While multiple ones of the inlet and outlet lines 108, 110 are shown connected through a respective manifold to the inflow and outflow valves 114, 116, each of the inlet and outlet lines 108, 110 may couple to individual valves.

Further, the inflow and/or outflow valves 114, 116 may function in a timed and/or pressure dependent manner whether or not operated by the actuation signals of the controller 112. In the case of a pressure dependent embodiment, determination of the pressure within the interior volume of the vessel may be made with a pressure transducer (connected to the comptroller 112) disposed to be in communication with the interior volume. Further, while the inflow valve(s) (and/or the outflow valve(s)) may be controlled to turn the flow of the dense phase gas on and off, it is also contemplated that the flow rate of the dense phase gas may be varied between a first flow rate and a second flow rate, where the first flow rate is lower than the second flow rate. In the former embodiment a flow rate of the dense phase gas is turned completely off during a cleaning cycle, while in the latter embodiment some flow of the dense phase gas is maintained throughout the cleaning cycle.

Pulsed application of the carbon dioxide through the inlet line 108 also acts to mechanically dislodge adhered material, such as organic matter, cells and extracellular polymers, from surfaces of the article 102. This debris when adhered to the article 102 may protect against penetrability of the carbon dioxide. Removal of the debris from the surfaces of the article 102 therefore not only cleans the article but also permits interaction of the carbon dioxide with the article 102 for sterilization purposes.

For some embodiments, pulses of the flow of the carbon dioxide delivered via the inlet line 108 into the vessel 104 last for less than one minute, less than ten seconds, or less than one second. These pulses occur by manipulation of the inflow valve 114, for example, and as defined herein refer to a period of time in which some positive pressure is applied to the vessel 104 delineated by durations between such releases from the source 106 through the inflow valve 114. Multiple pulses may occur to achieve pressurization of the vessel 104 prior to depressurization that completes one cycle of pressurization and depressurization. Frequency of the cycles of pressurization and depressurization may be less than six minutes, less than three minutes or less than two minutes.

Duration of the pulses and/or frequency of the pressurization and depressurization cycles create turbulence or fluid motion within the vessel 104 that may be constant and consistent throughout the cleaning cycle. Again, such agitation acts to mechanically dislodge adhered material from surfaces of the article 102. For example, percentage of time that conditions inside the vessel 104 are at equilibrium or not being changed may be less than 50%, less than 25% or less than 10% for the cleaning cycle.

In some embodiments, pulses of the flow of the carbon dioxide delivered into the vessel 104 from the source 106 alternate sequentially between different individual ones or sets of the inlet lines 108. Likewise, relieving pressure from the vessel 104 may occur through a patterned or random discharge sequence through different individual ones or sets of the outlet lines 110. Such sequenced alternating among different ones of the inlet and/or outlet lines 108, 110 may occur with, or within, each cycle of pressurization and depressurization of the vessel 104. While the alternating further adds to the agitation introduced by the flow of the carbon dioxide, pulsing for some embodiments occurs through all of the inlet lines 108 at the same time.

With every opening of the outflow valve 116, a portion of the cleaning fluid discharges to a drain 118. Fresh cleaning fluid replenishes inside the vessel 104 and includes additional carbon dioxide supplied from the source 106 upon each opening of the inflow valve 114. Circulation of the cleaning fluid through the vessel 104 in this manner flushes away the debris formerly attached to the article 102 to avoid dilution of the carbon dioxide inside the vessel 104. In some embodiments, a closed loop returns the carbon dioxide to the supply 106 after recovery from the drain 118 and subsequent decontaminating and regenerating of the carbon dioxide.

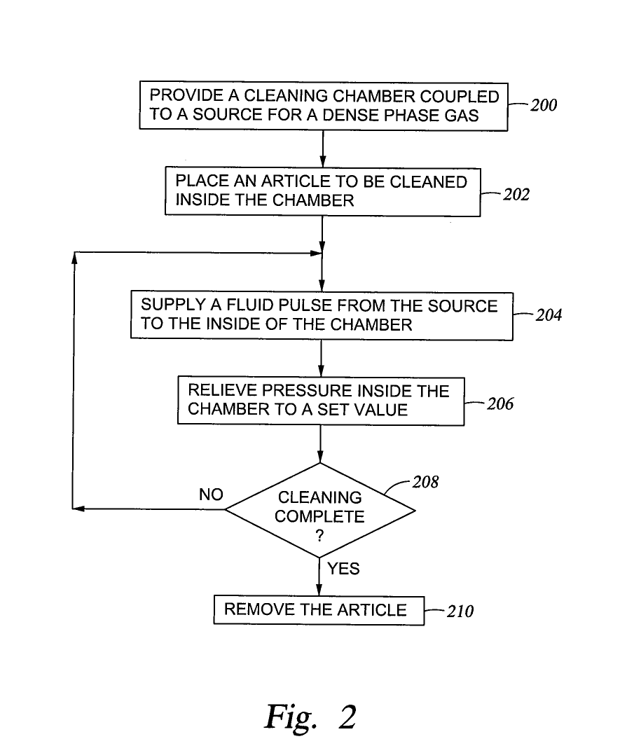

FIG. 2 illustrates a flow chart for a method of cleaning an article based on, for example, the system shown in FIG. 1 and described above. As depicted in setup step 200, the method utilizes a cleaning chamber or vessel coupled to a source for a dense phase gas. For some embodiments, the source may contain liquid carbon dioxide or supercritical carbon dioxide. Placing the article to be cleaned inside the chamber occurs in loading step 202. Next, pulsing flow into the chamber in fluid supply step 204 includes introducing fluid from the source to the inside of the chamber. Opening appropriate inflow valve(s) between the source and the chamber for a discrete interval of time establishes the pulse into the chamber. In pressure relief step 206, opening outflow valve(s) permits exiting flow of cleaning fluid out of the chamber. Decision step 208 determines whether cleaning of the article is complete or if the method should loop back to the fluid supply step 204. This determination may be based on, for example, input from a user, a selected period of time, or number of cycles through the fluid supply step 204 and the pressure relief step 206. During at least part of cycling through the fluid supply step 204 and the pressure relief step 206, pressure and temperature conditions in the chamber establish the dense phase gas that envelops the article and that is made up of the fluid supplied from the source.

In one embodiment, intermittent opening and closing of the inflow and outflow valves in the fluid supply and pressure relief steps 204, 206 occurs intermittently and in cycles. The inflow valves may remain open in the fluid supply step 204 until an identified maximum pressure, such as a dense phase pressure (above about 4800 kilopascal (kPa) at about 20-25° C. for carbon dioxide) or a supercritical pressure (above about 7821 kPa for carbon dioxide above 31.1° C.), is reached in the interior volume of the vessel at which time the inflow valves close. Complete closing of the inflow valves may trigger opening of the outflow valves, according to one embodiment. The outflow valves may remain open in the pressure relief step 206 until an identified minimum pressure, such as a pressure below dense or supercritical phase conditions (e.g., about 3500 kilopascal (kPa) at about 20-25° C. for carbon dioxide), is reached. The minimum pressure in the vessel may trigger closing of the outflow valves and repeating of the cycle throughout the cleaning of the article.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A system for cleaning articles, comprising:
a cleaning pressure vessel defining an interior volume and a support member for supporting the article in the interior volume;
a fluid source coupled via an inlet line to the vessel, wherein the fluid source supplies a dense phase gas to the interior volume of the vessel; and
a controller configured to pulse flow of the dense phase gas from the fluid source to the vessel, thereby repeatedly cycling pressure inside the vessel between identified minimum and maximum pressures throughout a cleaning process during which the article is cleaned.

2. The system of claim 1, wherein the inlet line comprises at least two injection ports into the interior volume of the vessel and disposed at spaced locations about the vessel.

3. The system of claim 1, wherein the controller is configured to pulse flow of the dense phase gas from the fluid source to the vessel with a pulse time of less than one minute.

4. The system of claim 1, wherein the controller is configured to maintain equilibrium conditions in the vessel less than 50% of time during the cleaning process.

5. The system of claim 1, wherein the controller is configured to pulse flow of the dense phase gas from the fluid source sequentially through different injection ports into the vessel.

6. The system of claim 1, wherein the fluid source comprises one of liquefied carbon dioxide and supercritical carbon dioxide.

7. The system of claim 1, further comprising an outflow valve disposed along a pressure relief outlet in fluid communication with the inside of the vessel and an inflow valve disposed along the inlet line, wherein the controller is configured to operate the outflow valve to be open alternately with respect to the inflow valve being open.

8. A method of cleaning articles, comprising:
placing an article inside a cleaning vessel;
supplying a fluid pulse from a source for a dense phase gas to the inside of the cleaning vessel, the fluid pulse being directed at the article to effect cleaning of the article;
relieving pressure from the inside of the cleaning vessel;
repeating the supplying and the relieving according to a predefined pulse cycle pattern to repeatedly cycle pressure inside the vessel between identified minimum and maximum pressures during the cleaning of the article; and
removing the article from the vessel after completion of the cleaning.

9. The method of claim 8, wherein supplying the fluid pulse comprises injecting the dense phase gas at spaced locations about the vessel.

10. The method of claim 8, wherein supplying the fluid pulse occurs with a pulse time of less than one minute.

11. The method of claim 8, wherein cycling between the minimum and maximum pressures repeats at a frequency of less than every six minutes.

12. The method of claim 8, wherein the predefined pulse cycle pattern maintains equilibrium conditions in the vessel less than 50% of time during the cleaning of the article.

13. The method of claim 8, wherein supplying the fluid pulse comprises injecting the dense phase gas sequentially at spaced locations about the vessel.

14. The method of claim 8, wherein the maximum and minimum pressures are respectively above a dense phase pressure of the dense phase gas at a given temperature and below the dense phase pressure at the given temperature.

15. The method of claim 8, wherein the maximum and minimum pressures are respectively above a supercritical pressure of the dense phase gas and the minimum pressure is below the supercritical pressure.

16. The method of claim 8, wherein supplying the fluid pulse comprises opening an inflow valve along an inlet line coupling the source to the vessel and relieving the pressure comprises opening an outflow valve disposed along a pressure relief outlet in fluid communication with the inside of the vessel, wherein the outflow valve is open alternately with respect to the inflow valve being open.

17. The method of claim 8, further comprising establishing conditions to support the dense phase gas within the inside of the cleaning vessel, wherein the dense phase gas comprises one of liquefied carbon dioxide and supercritical carbon dioxide.

18. A method of cleaning an article, comprising:
exposing a solid external surface of the article to a dense phase gas disposed inside a cleaning vessel, wherein the dense phase gas comprises at least one of liquefied carbon dioxide and supercritical carbon dioxide; and
pulsing flow of the dense phase gas passing through the inside of the vessel, wherein the pulsing flow occurs while the article is disposed in the vessel and creates repeated up and down pressure fluctuations inside the vessel, and wherein the pulsing flow of the dense phase gas is directed at the article to effect cleaning of the article.

19. The method of claim 18, wherein the dense phase gas further comprises ozone.

20. The method of claim 18, wherein the pulsing flow is directed at the article from multiple spaced apart locations to effect cleaning of the article by inactivating microorganisms disposed on the article.
